(19) United States
(12) Patent Application Publication
(10) Pub. No.: US 2025/0267235 A1
(43) Pub. Date: Aug. 21, 2025

(54) SPECIAL EFFECT PROCESSING METHOD AND APPARATUS, ELECTRONIC DEVICE, AND STORAGE MEDIUM

(71) Applicant: Beijing Zitiao Network Technology Co., Ltd., Beijing (CN)

(72) Inventors: Qi YUAN, Beijing (CN); Tinglei FENG, Beijing (CN); Nanjiang XIE, Beijing (CN); Jiajia LI, Beijing (CN); Chun LIU, Beijing (CN)

(21) Appl. No.: 19/059,070

(22) Filed: Feb. 20, 2025

(30) Foreign Application Priority Data
Feb. 20, 2024 (CN) 202410190835.1

(51) Int. Cl. H04N 5/262; G06T 3/40; G06T 5/50

(52) U.S. Cl. CPC H04N 5/2621; G06T 3/40; G06T 5/50; G06T 2207/20221

(57) ABSTRACT

A special effect processing method and apparatus, an electronic device, and a storage medium. The method includes: performing, in response to a shooting trigger operation, image capture by using a target shooting apparatus, to obtain a first image, and displaying the first image in a shooting interface; obtaining an uploaded image as a second image in response to an uploading trigger operation, displaying the second image in the shooting interface, and determining at least one third image from the second image; and displaying, in response to a special effect trigger operation, a special effect image corresponding to the first image and the third image. In the method, an effect of customizing all images required during special effect processing is achieved, thereby enhancing the flexibility of the special effect processing and enriching a special effect display effect of the special effect image.

### CROSS-REFERENCE TO RELATED APPLICATION

This application claims the priority and benefits of the Chinese Patent Applications No. 202410190835.1, which was filed on Feb. 20, 2024, the disclosure of which is incorporated herein by reference in its entirety as part of the present application.

### TECHNICAL FIELD

Embodiments of the present disclosure relate to computer application technologies, and in particular, to a special effect processing method and apparatus, an electronic device, and a storage medium.

### BACKGROUND

With the development of network technologies, an increasing number of applications are coming into life of users, especially a range of software applications that can be used to shoot short videos, which are popular among users.

In the related art, a software developer may add various special effect props to an application for a user to use during shooting a video. However, the special effect props currently provided for the user are very limited, and the quality of the video and the richness of video content need to be further improved, especially for image processing special effect props. Generally, an original image to be processed is obtained, and then the original image is further processed based on a preset template corresponding to a triggered and selected special effect prop, such that a special effect image obtained through processing presents a corresponding special effect.

However, such an image processing manner uses the preset template that is preset and fixed, and cannot be edited by the user. As a result, a special effect display effect of the special effect image produced based on the special effect prop is monotonous, which cannot meet a personalized editing requirement of the user for special effects and show some limitations.

### SUMMARY

Embodiments of the present disclosure provide a special effect processing method and apparatus, an electronic device, and a storage medium, to achieve an effect of customizing all images required during special effect processing, thereby enhancing the flexibility of the special effect processing, enriching a special effect display effect of a special effect image, and improving the user experience.

According to a first aspect, an embodiment of the present disclosure provides a special effect processing method. The method includes: performing, in response to a shooting trigger operation, image capture by using a target shooting apparatus, to obtain a first image, and displaying the first image in a shooting interface; obtaining an uploaded image as a second image in response to an uploading trigger operation, displaying the second image in the shooting interface, and determining at least one third image from the second image; and displaying, in response to a special effect trigger operation, a special effect image corresponding to the first image and the third image.

According to a second aspect, an embodiment of the present disclosure further provides a special effect processing apparatus. The apparatus includes: an image capture module configured to perform, in response to a shooting trigger operation, image capture by using a target shooting apparatus, to obtain a first image, and display the first image in a shooting interface; an image uploading module configured to obtain an uploaded image as a second image in response to an uploading trigger operation, display the second image in the shooting interface, and determine at least one third image from the second image; and an image display module configured to display, in response to a special effect trigger operation, a special effect image corresponding to the first image and the third image.

According to a third aspect, an embodiment of the present disclosure further provides an electronic device. The electronic device includes: one or more processors; and a storage apparatus configured to store one or more programs, where the one or more programs, when executed by the one or more processors, cause the one or more processors to implement the special effect processing method described in any one of the embodiments of the present disclosure.

According to a fourth aspect, an embodiment of the present disclosure further provides a storage medium containing computer-executable instructions, where the computer-executable instructions, when executed by a computer processor, are used to perform the special effect processing method described in any one of the embodiments of the present disclosure.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the accompanying drawings, the same or similar reference numerals denote the same or similar elements. It should be understood that the accompanying drawings are schematic and that parts and elements are not necessarily drawn to scale.

FIG. 1 is a schematic flowchart of a special effect processing method according to an embodiment of the present disclosure;

FIG. 2 is a schematic interface diagram of a shooting interface according to an embodiment of the present disclosure;

FIG. 3 is another schematic interface diagram of a shooting interface according to an embodiment of the present disclosure;

FIG. 4 is a schematic flowchart of another special effect processing method according to an embodiment of the present disclosure;

FIG. 5 is a schematic flowchart of signaling in a special effect processing method according to an embodiment of the present disclosure;

FIG. 6 is a schematic diagram of a structure of a special effect processing apparatus according to an embodiment of the present disclosure; and

FIG. 7 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include” used herein and the variations thereof are an open-ended inclusion, namely, “include but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, a user shall be informed of a type, a range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

Before the technical solutions are described, an exemplary description may be given to the application scenario. The technical solutions may be applied to any image processing scenario. For example, in a general process of image processing, an original image to be processed is obtained, and then the original image is processed based on a preset template corresponding to a triggered and selected special effect prop, such that a special effect image obtained through processing presents a corresponding special effect. That is, the original image is sent to a server, such that the server processes the original image based on the preset template, to obtain the special effect image, and feeds the special effect image back to a client. Such an image processing manner uses the preset template that is preset and fixed, and cannot be edited by a user. As a result, a special effect display effect of the special effect image produced based on the special effect prop is monotonous, which cannot meet a personalized editing requirement of the user for special effects and show some limitations.

In view of this, based on the technical solutions of the embodiments of the present disclosure, in the process of image processing, image capture is performed in response to a shooting trigger operation by using a target shooting apparatus, to obtain a first image. In addition, an uploaded image is obtained as a second image in response to an uploading trigger operation, the second image is displayed in the shooting interface, and at least one third image is determined from the second image. Further, a special effect image corresponding to the first image and the third image is displayed in response to a special effect trigger operation. In this way, an effect of customizing all images required during special effect processing is achieved. Therefore, the flexibility of the special effect processing is enhanced, a special effect display effect of a special effect image is enriched, and the user experience is improved.

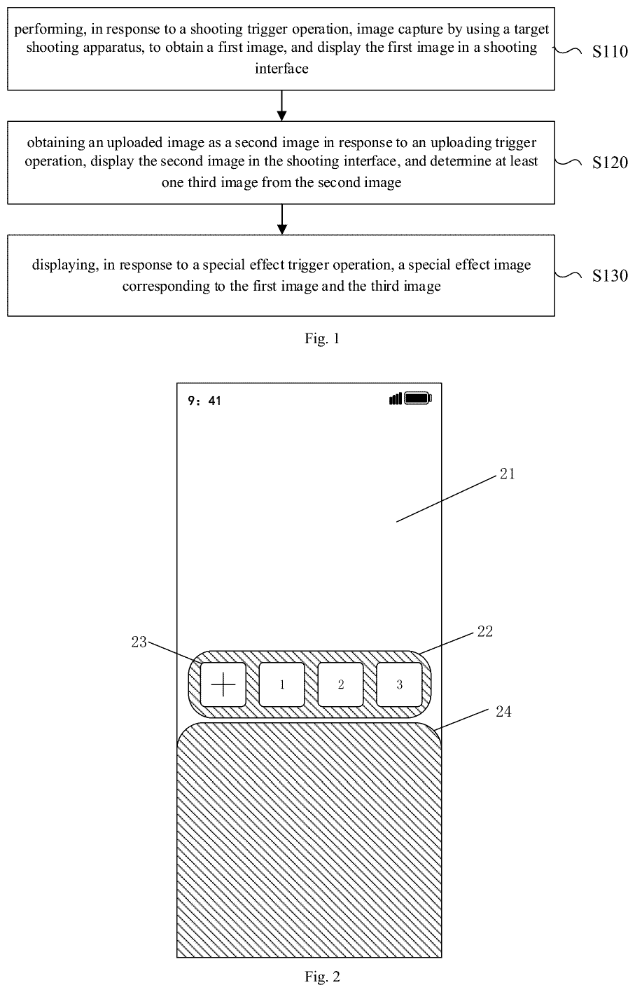

FIG. 1 is a schematic flowchart of a special effect processing method according to an embodiment of the present disclosure. This embodiment of the present disclosure is applicable to a case where any two images are processed to obtain a special effect image. The method may be performed by a special effect processing apparatus. The apparatus may be implemented in the form of software and/or hardware. Optionally, the apparatus may be implemented by an electronic device, and the electronic device may be a mobile terminal, a PC, a server, or the like.

As shown in FIG. 1, the method in this embodiment may specifically include the following steps.

S110: performing, in response to a shooting trigger operation, image capture by using a target shooting apparatus, to obtain a first image, and display the first image in a shooting interface.

The shooting trigger operation may be understood as an operation that triggers image capture. Optionally, the shooting trigger operation may include at least one of the following: triggering a shoot control; triggering a shooting wake-up word using audio information; and a current body movement being consistent with a preset body movement. For example, a control that may be triggered for image capture may be preset in application software or an application that supports an image capture function. When it is detected that a user triggers the control, it may be determined that the shooting trigger operation is detected. Further, a response is made to the shooting trigger operation by performing image capture by using the target shooting apparatus, to obtain the first image, and the first image is displayed in the shooting interface.

The target shooting apparatus may be a shooting apparatus provided on a terminal device, such as a smartphone camera or a tablet camera. Alternatively, the target shooting apparatus may be a shooting apparatus connected to a terminal device, such as a camera. The first image may be understood as an image to be processed. The first image may be an image that includes image content to be added with a special effect. The image content to be added with the special effect may be any image content, optionally, a person, an animal, a plant, a building, or the like. For example, the first image may be an image including the face of the user. It should be noted that there may be one or more first images, and no matter whether there is one or more first images, the first image may be processed by using the technical solution provided in this embodiment of the present disclosure. The shooting interface may be understood as a visual interface for displaying images.

In practical application, a shooting start control may be preset in a display interface, and the shooting interface may be entered when a trigger operation for the control is detected. In this case, an image displayed in the shooting interface is an image in a view field of the target shooting apparatus. The user may update, by moving the target shooting apparatus, the image displayed in the shooting interface. Further, when it is detected that the user triggers a shoot operation (e.g., triggering the shoot control or clicking on a screen of the terminal device), an image displayed in a current shooting interface may be acquired by using the target shooting apparatus, and the acquired image is used as the first image. Further, the first image may be displayed in the shooting interface.

S120: obtaining an uploaded image as a second image in response to an uploading trigger operation, display the second image in the shooting interface, and determine at least one third image from the second image.

The uploading trigger operation may be understood as an operation that triggers an upload of an image and/or a video. Optionally, the uploading trigger operation may include at least one of the following: triggering an upload control; receiving an image upload instruction; and audio information including a wake-up word corresponding to the uploading trigger operation, etc. For example, the upload control may be preset in the shooting interface. When it is detected that the control is triggered, it may be determined that the uploading trigger operation is detected, and a response is made to the uploading trigger operation. The uploaded image is obtained as the second image, and the second image is displayed in the shooting interface.

The second image may be an image to be processed. Optionally, the second image may be an image pre-stored in a target storage space (such as an image library of the application software or a gallery of a terminal), or may be an image received and uploaded from an external device, etc. The second image may be an image including any image content. It should be noted that the uploaded second image and the shot first image may include the same type of image content. For example, when the first image includes a face of a person, the uploaded second image may also include a face of a person. It should be further noted that there may be one or more second images.

In practical application, the image upload control may be preset in the display interface, and a to-be-uploaded image path selection page may be popped up when a trigger operation for the control is detected. The selection page may include at least three to-be-uploaded image paths such as a local gallery of the terminal, the image library, and a third-party device. Further, when a selection trigger operation for any to-be-uploaded image path is detected, an image display page corresponding to the to-be-uploaded image path may be displayed in the display interface. The page may include a plurality of images to be uploaded associated with the to-be-uploaded image path. The user may perform, through the selection trigger operation, selection from the displayed plurality of images to be uploaded. Further, when a selection trigger operation for at least one image to be uploaded is detected, at least one selected image to be uploaded may be used as the uploaded image. Then, when a selection complete operation is detected, it may be determined that the uploading trigger operation is detected. Further, the response is made to the uploading trigger operation, the uploaded image is used as the second image, and the second image is displayed in the shooting interface.

It should be noted that an obtaining order of the first image and the second image is not specifically limited in this embodiment of the present disclosure. The first image may be obtained before the second image. Alternatively, the second image may be obtained before the first image. That is, the shooting trigger operation may be input before the uploading trigger operation. Alternatively, the uploading trigger operation may be input before the shooting trigger operation. In this embodiment, the shoot control and/or the upload control may be preset in the shooting interface, such that when the shooting interface is displayed, a trigger operation may be input for a corresponding control to obtain a corresponding image. The first image and the second image may be determined through at least two processes. The two processes may be separately described below.

In a first process, the shooting trigger operation is input before the uploading trigger operation. The shooting interface is displayed in response to a special effect trigger operation, where the image upload control is displayed in the shooting interface. An image shot by using the target shooting apparatus is obtained as the first image in response to the shooting trigger operation, and the first image is displayed in the shooting interface. One or more uploaded images are obtained as the second image in response to the uploading trigger operation acting on the image upload control, and the second image is displayed in the shooting interface.

In this embodiment, a control for triggering a special effect may be developed in advance in the application software or the application that supports the special effect processing function. Further, when it is detected that the user triggers the control, a response may be made to the trigger operation. As such, the shooting interface that includes the image upload control is displayed. The image upload control is a control that is triggered to perform an image upload process.

In practical application, when the special effect trigger operation is detected, a response is made to the special effect trigger operation, and the shooting interface is displayed, where the image upload control is displayed in the shooting interface. In addition, the image in the view field of the target shooting apparatus may be displayed in the shooting interface. Further, the shoot operation is input based on image content displayed in the shooting interface. When the shooting trigger operation is detected, a response is made to the shooting trigger operation by obtaining the image shot based on the target shooting apparatus as the first image, and the first image is displayed in the shooting interface. Further, when the trigger operation for the image upload control is detected, a response may be made to the trigger operation by obtaining the one or more uploaded images as the second image, and the second image is displayed in the shooting interface.

In a second process, the uploading trigger operation is input before the shooting trigger operation. One or more uploaded images are obtained as the second image in response to the uploading trigger operation, and the second image is displayed in the shooting interface. An image shot by using the target shooting apparatus is obtained as the first image in response to the trigger operation for the shoot control displayed in the shooting interface, and the first image is displayed in the shooting interface.

In practical application, when the uploading trigger operation is detected, the one or more uploaded images may be obtained as the second image and displayed in the shooting interface. Further, when the trigger operation for the shoot control is detected, a response may be made to the shooting trigger operation, the image shot by using the target shooting apparatus may be obtained, and the image may be displayed as the first image in the shooting interface.

It should be noted that the first image may be displayed in a variety of ways, optionally full display or thumbnail display. The second image may be displayed in a variety of ways, optionally full display or thumbnail display. It should be further noted that the first image and the second image may be displayed simultaneously in the shooting interface in a variety of ways, optionally layered display or regional display.

For example, FIG. 2 is a schematic interface diagram of the shooting interface. As shown in FIG. 2, the first image and the second image may be displayed in layers, where a layer 21 is used as a display layer of the first image, and a layer 22 is used as a display layer of the second image. Moreover, the first image may be fully displayed in the corresponding layer, and a thumbnail corresponding to each second image may be displayed in the corresponding layer. There may be three second images: a second image 1, a second image 2, and a second image 3. An image upload control 23 may be further displayed on the left of the second image in the same layer as the second image. In addition, a special effect prop display panel 24 may be further displayed in the same layer as the second image, where the special effect prop display panel may include a plurality of special effect prop identifiers. It should be noted that layered display has the benefits that full image content of the first image can be displayed, and the image content of the first image can also be seen through the display layer corresponding to the second image while the second image is displayed.

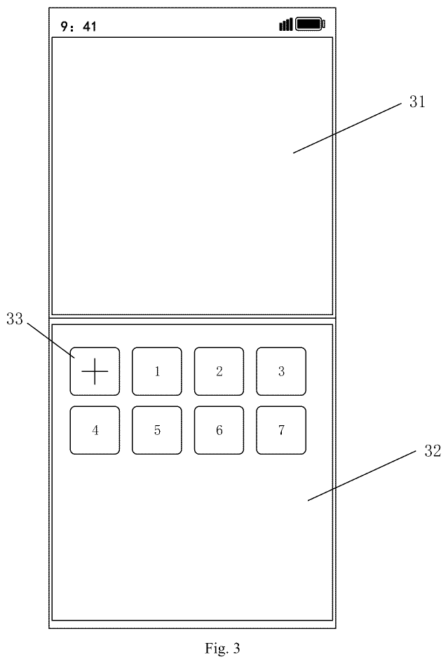

For example, FIG. 3 is another schematic interface diagram of the shooting interface. As shown in FIG. 3, the first image and the second image may be displayed in regions, where a region 31 is used as a display region of the first image, and a region 32 is used as a display region of the second image. Further, the first image may be displayed in the region 31 in the shooting interface, and the second image and an image upload control 33 may be displayed in the region 32 in the shooting interface. There are seven second images: a second image 1, a second image 2, a second image 3, a second image 4, a second image 5, a second image 6, and a second image 7. It should be noted that the first image may be displayed in the region 31 in at least two ways, optionally including full display or partial display. For example, in the case of partial display, the first image may be clipped based on a display size of the region 31, to obtain a clipped image, and then the clipped image may be displayed in the region 31. When the first image is clipped, the first image may be clipped based on an image clipping trigger operation input by the user, or may be clipped automatically after the application software detects the first image, which is not specifically limited in this embodiment of the present disclosure. For example, in the case of full display, the first image may be scaled based on a display size of the region 31, to obtain a scaled first image, and then the scaled first image may be displayed in the region 31.

Further, the at least one third image may be determined from the second image. The third image may be an image in the second image. It should be noted that the third image may be all second images, or may be at least one image in the second image. When the third image is all the second images, all the uploaded images may be used as third images. When the third image is at least one image in the second image, at least one second image may be selected from the second image as the third image.

Optionally, the determining at least one third image from the second image includes: using a selected second image as the third image in response to a selection trigger operation for the at least one second image.

In this embodiment of the present disclosure, the selection trigger operation may be an operation that triggers image selection. The selection trigger operation may be any operation acting on the second image. Optionally, the selection trigger operation may be a click operation for the second image. The click operation may be a single-click operation or a multi-click operation (e.g., a double-click operation). To facilitate an operation of the user, the selection trigger operation may alternatively be that when it is detected that the user operates on the second image for a preset time based on an input device or a touch point, the operation may be used as the selection trigger operation for the second image.

In practical application, when the second image is obtained and displayed in the shooting interface, the selection trigger operation may be input for the displayed second image. Further, when the selection trigger operation for the at least one second image is detected, a response may be made to the selection trigger operation, and the selected second image can be used as the third image. Such a setting has the benefits of enriching manners for determining the third image to be processed and enhancing the interactivity between the user and the application software, thereby enriching an image display effect of a special effect image.

S130: displaying, in response to a special effect trigger operation, a special effect image corresponding to the first image and the third image.

In this embodiment of the present disclosure, the special effect trigger operation may be understood as an operation that triggers image processing. The special effect trigger operation may include at least one of the following: triggering an image processing control; receiving an image processing instruction; and audio information including an audio keyword corresponding to the special effect trigger operation, etc. For example, the image processing control may be preset in the shooting interface, and when a trigger operation for the control is detected, it may be determined that the special effect trigger operation is detected. Further, a response is made to the special effect trigger operation, and the special effect image corresponding to the first image and the third image is displayed.

The special effect image may be understood as an image obtained by performing special effect processing on the first image and the third image. It should be noted that there may be one or more first images and one or more third images. Therefore, there may be a plurality of cases for the special effect image corresponding to the first image and the third image. The plurality of cases may be separately described below.

In the first case, when there is one first image and one third image, the special effect image may be an image obtained by performing special effect processing on the first image and the third image.

In the second case, when there is one first image and a plurality of third images, the special effect image includes special effect images obtained by performing special effect processing on the first image and each third image, that is, special effect processing may be performed on the first image and each third image, to obtain a plurality of special effect images. Further, the plurality of special effect images obtained may be used as special effect images corresponding to the first image and the third images. Such a setting has the benefits of enhancing the flexibility of image special effect processing when there are a plurality of third images, helping generate a set of special effect images corresponding to the first image, and enhancing a display effect of the special effect image.

In the third case, when there are a plurality of first images and one third image, the special effect image may include a plurality of images obtained by performing special effect processing on the third image and each first image, that is, special effect processing may be performed on the third image and each first image, to obtain a plurality of special effect images. Further, the plurality of special effect images obtained may be used as special effect images corresponding to the first images and the third image.

In the fourth case, when there are a plurality of first images and a plurality of third images, the special effect image may include special effect images obtained by performing special effect processing on each first image and each third image according to a preset image processing rule. Optionally, the preset image processing rule may be random special effect processing, sequential special effect processing, or the like.

In this embodiment, the special effect image corresponding to the first image and the third image may be an image determined in a plurality of special effect processing manners. Optionally, the special effect processing manners may include image fusion, style transfer, and/or the like. Accordingly, the special effect image may include a fused image of the first image and the third image, and/or a style transferred image obtained by transferring an image style of the third image to the first image or transferring an image style of the first image to the third image.

Optionally, when the special effect image is the fused image, the fused image of the first image and the third image may be an image that includes both at least part of image content of the first image and at least part of image content of the third image. The first image is a shot image, and the third image is an uploaded image. In general, the third image may be used as a base image of the fused image, and the first image may be used as an image fused to the base image, to obtain the fused image of the first image and the third image. In this case, the obtained fused image may be an image that meets an image fusion requirement of the user.

Optionally, the fused image obtained in the above manner may be obtained by fusing the at least part of image content of the first image to an associated image region in the third image.

In this embodiment of the present disclosure, the at least part of image content may be preset image content to be subjected to image fusion. The at least part of image content may be any image content of the first image. Optionally, the at least part of image content may be an image of a human face, an image of a human limb, an image of an animal face, an image of an action limb, a plant, a building, etc. The associated image region may be an image region associated with an object type included in the at least part of image content. For example, when the object type included in the at least part of image content is the human face, the associated image region may be a human face region in the third image; or when the object type included in the at least part of image content is the animal face, the associated image region may be an animal face region in the third image.

In practical application, when the first image and the third image are fused, the at least part of image content of the first image may be determined, and the at least part of image content may be extracted. Further, the associated image region in the third image may be determined based on the at least part of image content extracted, and the at least part of image content may be fused to the associated image region in the third image. Therefore, the special effect image corresponding to the first image and the third image may be obtained. Such a setting has the benefits of implementing associated and matched fusion of image content in an image fusion process, thereby improving the realistic level of the special effect image and making the finally obtained special effect image more natural.

Optionally, when the special effect image is the style transferred image, after the first image and the third image are obtained, the image style of the first image may be determined, the image style may be transferred to each third image in a preset style transfer mode, to obtain at least one style transferred image, and the obtained style transferred image may be used as the special effect image corresponding to the first image and the third image. Alternatively, for each third image, an image style of the third image may be determined, the image style may be transferred to the first image in a preset style transfer mode, to obtain at least one style transferred image, and the obtained style transferred image is used as the special effect image corresponding to the first image and the third image.

It should be noted that there may be one or more special effect images corresponding to the first image and the third image. If there is one special effect image, when the special effect image is displayed, the special effect image may be displayed directly. If there are a plurality of special effect images, displaying the special effect image corresponding to the first image and the third image includes at least one of the following operations.

A first operation is playing the plurality of special effect images corresponding to the first image and the third image in a preset playback order.

In this embodiment of the present disclosure, the preset playback order may be a preset order in which the special effect images are played when there are the plurality of special effect images. The preset playback order may be any playback order. Optionally, an order of generation timestamps of the special effect images may be used as the preset playback order. Alternatively, a selection order of the third images may be used as the preset playback order. Alternatively, a playback order set according to another rule may be used as the preset playback order.

In practical application, if there are the plurality of special effect images, when the plurality of special effect images are obtained and then displayed, the plurality of special effect images obtained may be played in the preset playback order.

A second operation is generating a special effect video based on the plurality of special effect images corresponding to the first image and the third image, and playing the special effect video.

In this embodiment of the present disclosure, after the plurality of special effect images are obtained, the plurality of special effect images may be edited based on a video editing function, to add text, a filter, music, or other content to the plurality of special effect images. When a trigger operation for an editing complete control is detected, an edited video may be obtained. The obtained video may be used as the special effect video, and the special effect video may be played, to display the plurality of special effect images corresponding to the first image and the third image based on the played special effect video.

A third operation is splicing the plurality of special effect images corresponding to the first image and the third image in a preset splicing manner based on an original size or after scaling, so as to obtain a spliced image, and displaying the spliced image.

In this embodiment of the present disclosure, the original size may be a corresponding image size used when the special effect images are obtained. The preset splicing manner may be a preset image splicing manner. The preset splicing manner may be any splicing manner, optionally, horizontal splicing, vertical splicing, grid splicing, random splicing, or the like.

In practical application, after the plurality of special effect images corresponding to the first image and the third image are obtained, the plurality of special effect images may be spliced in the preset splicing manner based on the original size, so as to obtain the spliced image, and the spliced image may be displayed. Alternatively, the plurality of special effect images may be separately scaled based on a preset scaling ratio, so as to obtain a plurality of scaled special effect images, then the plurality of scaled special effect images may be spliced in the preset splicing manner, so as to obtain the spliced image, and the spliced image may be displayed.

It should be noted that displaying the special effect image in the above three manners has the benefits of enhancing the diversity of the special effect image display manners, improving the flexibility and intelligence of a special effect image display operation, and enriching the interestingness of special effect props, thereby improving the user experience.

According to the technical solution of this embodiment of the present disclosure, image capture is performed in response to the shooting trigger operation by using the target shooting apparatus, to obtain the first image, and the first image is displayed in the shooting interface. Then, the uploaded image is obtained as the second image in response to the uploading trigger operation, the second image is displayed in the shooting interface, and the at least one third image is determined from the second image. In this way, an original image to be processed can be obtained by using a plurality of image obtaining manners, such that the user can customize the original image, and the flexibility of the image obtaining manners is enhanced. Further, the special effect image corresponding to the first image and the third image is displayed in response to the special effect trigger operation. In this way, problems of a monotonous special effect display effect of a special effect image produced based on a special effect prop and the like caused by the fact that a preset template corresponding to the special effect prop cannot be edited in the related art are solved, and an effect of customizing all images required during special effect processing is achieved. Therefore, the flexibility of the special effect processing is enhanced, a special effect display effect of the special effect image is enriched, and the user experience is improved.

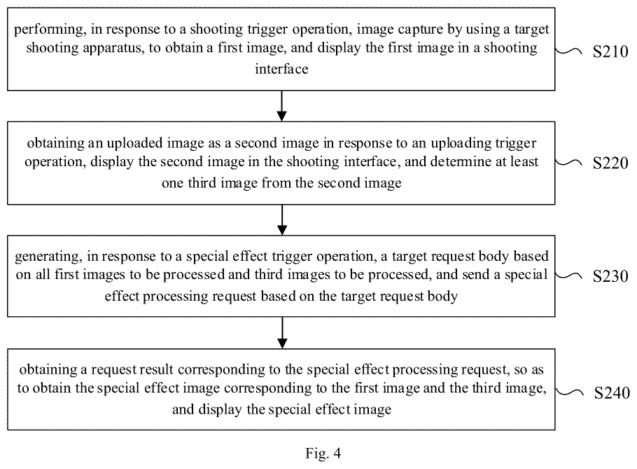

FIG. 4 is a schematic flowchart of another special effect processing method according to an embodiment of the present disclosure. In the technical solution of this embodiment, on the basis of the above embodiment, a target request body is generated based on all first images to be processed and third images to be processed, and a special effect processing request is sent based on the target request body. Further, a request result corresponding to the special effect processing request is obtained, and the special effect image corresponding to the first image and the third image is obtained based on the request result, and is displayed. For a specific implementation, reference may be made to the descriptions of this embodiment. Details about technical features that are the same as or similar to those in the foregoing embodiment are not repeated herein.

As shown in FIG. 4, the method in this embodiment may specifically include the following steps.

S210: performing, in response to a shooting trigger operation, image capture by using a target shooting apparatus, to obtain a first image, and display the first image in a shooting interface.

S220: obtaining an uploaded image as a second image in response to an uploading trigger operation, display the second image in the shooting interface, and determine at least one third image from the second image.

S230: generating, in response to a special effect trigger operation, a target request body based on all first images to be processed and third images to be processed, and send a special effect processing request based on the target request body.

In this embodiment of the present disclosure, all the first images to be processed and the third images to be processed may be all first images to be subjected to special effect processing and third images to be subjected to special effect processing, that is, a number of all the first images to be processed and the third images to be processed may be a sum of a number of shot first images and a number of selected third images. For example, assuming that there is one first image and three third images, the number of all the first images to be processed and the third images to be processed may be four.

It can be understood that a request body refers to important data carried in a request when the request is sent by a client to a server, and is a core of the request. The request body is a part of the request and usually carries a parameter of the request. The request body, a request header, and a request line constitute three parts of the request. In this embodiment of the present disclosure, the target request body may be a component of the special effect processing request for transmitting, to the server, a parameter, content, or data required for the special effect processing request. The target request body may include image data and special effect associated parameters of all the first images to be processed and the third images to be processed. The special effect processing request may be understood as a request message sent by the client to the server, and the request message is used to request the server to perform special effect processing on the image.

It should be noted that a special effect image may be determined based on the first image and the third image, and the first image and the third image play different roles in image processing. Therefore, in order to enable the server to distinguish the first image from the third image in the special effect processing request, at least two different slots may be provided in the target request body when the target request body is generated based on the first image and the third image. Further, corresponding slots may be separately filled with the first image and the third image, and the image data of the first image, the image data of the third image, and the special effect associated parameters may be determined separately. Further, the target request body may be determined based on the image data and the special effect associated parameters of the first image and the third image.

Optionally, the generating a target request body based on all first images to be processed and third images to be processed includes: filling preset receiving slots corresponding to the first image and the third image with all the first images to be processed and the third images to be processed one by one; using images filling the preset receiving slot as images to be processed, and for each of the images to be processed, obtaining a special effect associated parameter corresponding to an image to be processed, and processing the image to be processed based on the special effect associated parameter corresponding to the image to be processed, to obtain target image data corresponding to the image to be processed; and generating the target request body based on target image data and special effect associated parameters corresponding to all the first images to be processed and the third images to be processed.

In this embodiment of the present disclosure, the preset receiving slot may be a slot preset in the request body for receiving data. The preset receiving slots include a first preset slot corresponding to the first image and a second preset slot corresponding to the third image. Specifically, the first preset slot may be filled with all the first images one by one, and the second preset slot may be filled with all the third images one by one. The corresponding preset receiving slots are separately provided for the first image and the third image, such that the uploaded image and the shot image may be processed as data of two parallel links. Compared with a related special effect processing technology in which only one of the uploaded image and the shot image can be selected as an image to be processed, this expands an interaction mode for image customization, thereby enriching effects of the special effect image.

In this embodiment of the present disclosure, the special effect associated parameter may be understood as a parameter associated with image special effect processing. The special effect associated parameter may include a plurality of associated parameters, optionally including a request associated parameter and an effect associated parameter. The request associated parameter may be a parameter associated with a generation mode of the target request body. The effect associated parameter is a parameter associated with a display effect of the special effect image. The request associated parameter includes at least a total number of images with which the preset receiving slots are to be filled and a total number of images with which the preset receiving slots have been filled. The total number of images with which the preset receiving slots are to be filled may be understood as a total number of the first images to be processed or a total number of the third images to be processed. The total number of images with which the preset receiving slots have been filled may be understood as a number of first images with which the corresponding preset receiving slot has been filled or a number of third images with which the corresponding preset receiving slot has been filled. The target image data may be understood as data obtained by encoding the image in a preset encoding mode. The target image data may be data that can represent the corresponding image and can fill the request body.

It should be noted that including the request associated parameter and the effect associated parameter in the special effect associated parameter has the benefits of performing a process of generating the special effect processing request based on the request associated parameter and performing an image special effect processing process based on the effect associated parameter, thereby improving the efficiency of image special effect processing and improving the display effect of the special effect image.

In practical application, after all the first images to be processed and the third images to be processed are determined, for each first image, the corresponding first preset receiving slot may be filled with the first image, and a special effect associated parameter corresponding to the first image may be obtained. For each third image, the corresponding second preset receiving slot may be filled with the third image, and a special effect associated parameter corresponding to the third image may be obtained. Further, an image filling the preset receiving slot may be used as an image to be processed, that is, the first image filling the first preset receiving slot and the third image filling the second preset receiving slot are used as images to be processed. Further, for each image to be processed, a special effect associated parameter corresponding to the image to be processed may be obtained, and the image to be processed may be processed based on the special effect associated parameter, to obtain target image data corresponding to the image to be processed. Further, it may be determined whether the target image data of all the first images to be processed and the third images to be processed is obtained. If not all the target image data of all the first images to be processed and the third images to be processed is obtained, the step of obtaining a special effect associated parameter corresponding to the image to be processed and processing the image to be processed based on the special effect associated parameter is repeatedly performed, until all the target image data of all the first images to be processed and the third images to be processed is obtained. Therefore, target image data corresponding to each first image and target image data corresponding to each third image may be obtained. Further, the target request body may be generated based on the target image data and the special effect associated parameters corresponding to all the first images to be processed and the target image data and the special effect associated parameters corresponding to all the third images to be processed. Such a setting has the benefits that filling different preset receiving slots with the first image and the third image achieves an effect of sending all the images to be processed and the special effect associated parameters to the server based on a single image processing request, thereby improving the flexibility of the special effect processing manners and improving the efficiency of special effect processing.

It should be noted that if two or more first images and/or third images exist, when the corresponding preset receiving slots are filled with all the first images to be processed and the third images to be processed one by one, the special effect associated parameter corresponding to the first image or the third image may be determined, and whether the total number of images with which the preset receiving slots have been filled is greater than or equal to the total number of images with which the preset receiving slots are to be filled may be determined based on the request associated parameter in the special effect associated parameter. If the total number of images with which the preset receiving slots have been filled is greater than or equal to the total number of images with which the preset receiving slots are to be filled, the image filling process is ended, and a target image data obtaining process is performed; or if the total number of images with which the preset receiving slots have been filled is not greater than or equal to the total number of images with which the preset receiving slots are to be filled, the image filling process continues to be performed, until the total number of images with which the preset receiving slots have been filled is greater than or equal to the total number of images with which the preset receiving slot are to be filled.

It should be further noted that if two or more first images and/or third images exist, when different preset receiving slots are filled with all the first images to be processed and the third images to be processed one by one, in order to avoid blocking of an image processing thread or incomplete data obtained, it is possible to fill the corresponding preset receiving slot with a first image or a third image and then fill the corresponding preset receiving slot with a next first image or a next third image after a period of time. As such, the first image and the third image can be successfully sent.

Optionally, the filling preset receiving slots corresponding to the first image and the third image with all the first images to be processed and the third images to be processed one by one includes: if two or more first images and/or third image exist and the preset receiving slots corresponding to the first image and the third image have been filled with images, filling a preset receiving slot corresponding to the first image with a subsequent first image and/or a preset receiving slot corresponding to the third image with a subsequent third image after an interval of a preset number of frames or a preset duration.

In this embodiment, the preset number of frames may be any number of frames, optionally, one frame, three frames, etc. The preset duration may be any duration, optionally, 0.1 seconds, 0.2 seconds, 0.3 seconds, etc.

In practical application, if two or more first images exist, for each first image, when the first preset receiving slot is filled with the first image, it may be determined whether the first preset receiving slot has been filled with a first image. Further, when it is determined that the first preset receiving slot has been filled with a first image, the first preset receiving slot may be filled with a subsequent first image after the interval of the preset number of frames or the preset duration. Similarly, if there are two or more third images, for each third image, when the second preset receiving slot is filled with the third image, it may be determined whether the second preset receiving slot has been filled with a third image. Further, when it is determined that the second preset receiving slot has been filled with a third image, the second preset receiving slot may be filled with a subsequent third image after the interval of the preset number of frames or the preset duration.

S240: obtaining a request result corresponding to the special effect processing request, so as to obtain the special effect image corresponding to the first image and the third image, and display the special effect image.

In this embodiment, the request result may be understood as a result representing a response of the server to the special effect processing request. The request result may include a request success or a request failure. When the request result is the request success, the obtained request result may further include the special effect image corresponding to the first image and the third image; or when the request result is the request failure, the obtained request result may further include information such as a reason for the request failure.

In practical application, after the special effect processing request is obtained, the special effect processing request may be sent to the server, such that the server performs special effect processing on the first image and the third image based on the special effect processing request, to generate the request result corresponding to the special effect processing request, and feeds the request result back to the client. Further, after the request result corresponding to the special effect processing request is obtained, the special effect image corresponding to the first image and the third image may be obtained based on the request result, and the special effect image may be displayed.

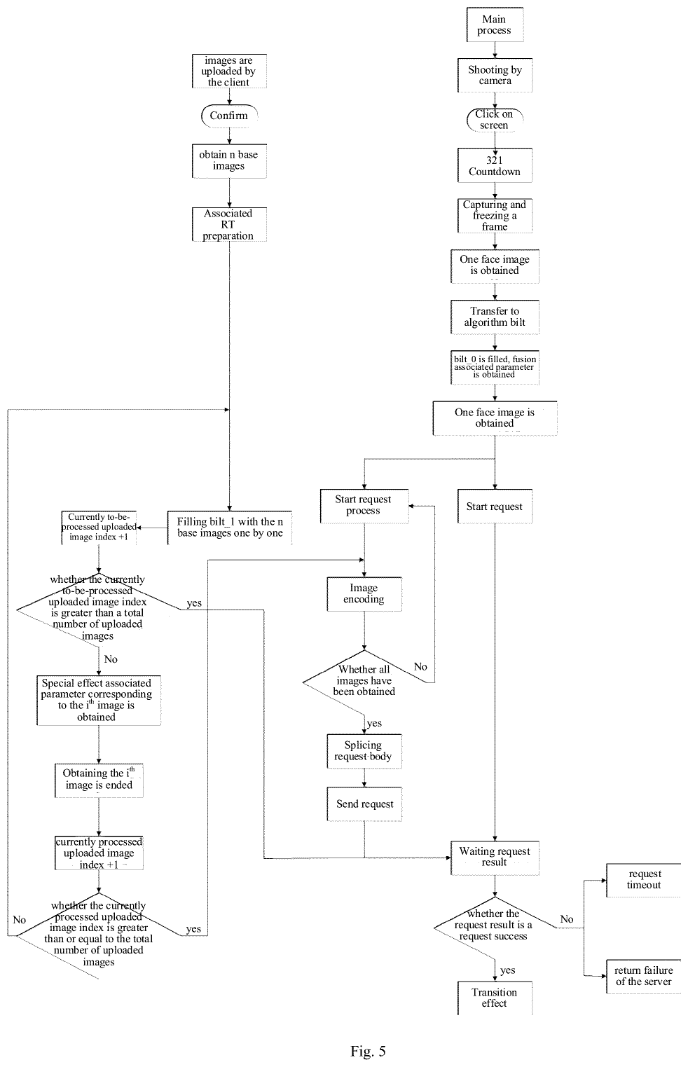

For example, FIG. 5 is a schematic flowchart of signaling in a special effect processing method according to an embodiment of the present disclosure. The special effect processing method provided in this embodiment of the present disclosure may be described with an example of using a fused image as the special effect image corresponding to the first image and the third image. As shown in FIG. 5, a camera is used as the target shooting apparatus, a face image is used as the first image, bilt_0 is used as the first preset receiving slot corresponding to the first image, a base image is used as the third image, and bilt_1 is used as the second preset receiving slot corresponding to the third image. First, shooting is performed by using the camera: when a click on a screen is detected, a shooting countdown starts, and a face image is obtained by capturing and freezing a frame. In this case, an image fusion loading progress starts. Then, face detection may be performed on the face image, bilt_0 is filled with the detected face image, a special effect associated parameter corresponding to the face image is obtained, and the face image and the special effect associated parameter are sent to an image fusion request process. For the base image, images are uploaded by the client to obtain n base images, and a rendering preparation is made for each base image. Then, a process of filling bilt_1 with the n base images one by one may be performed. In this process, for an i^{th} base image, built_1 is filled with the i^{th} base image, and a currently to-be-processed uploaded image index is increased by 1, so as to obtain an updated currently to-be-processed uploaded image index. Then, it is determined whether the currently to-be-processed uploaded image index is greater than a total number of uploaded images. If the currently to-be-processed uploaded image index is not greater than the total number of uploaded images, a special effect associated parameter corresponding to the i^{th} image is obtained. Then, after the interval of the preset number of frames or the preset duration, the process of obtaining the special effect associated parameter corresponding to the i^{th} image is ended, and a currently processed uploaded image index is increased by 1, so as to obtain an updated currently processed uploaded image index. Then, it may be determined whether the currently processed uploaded image index is greater than or equal to the total number of uploaded images. If the currently processed uploaded image index is not greater than or equal to the total number of uploaded images, a process of filling built_1 with an (i+1)^{th} image is performed; or if the currently processed uploaded image index is greater than or equal to the total number of uploaded images, an image encoding process is performed. The currently to-be-processed uploaded image index may be used to indicate a number of uploaded images that are currently recorded and on which parameter obtaining processing is to be performed. The total number of uploaded images may be understood as a total number of base images to be uploaded, that is, a total number of third images. The currently processed uploaded image index may be used to indicate a number of uploaded images that are currently recorded and on which parameter obtaining processing has been performed.

In the image encoding process, images filling bilt_0 and bilt_1 may be used as images to be processed, and for each image to be processed, the image to be processed may be encoded to obtain target image data corresponding to the image to be processed. Then, it may be determined whether target image data corresponding to all images to be processed has been obtained. If not all the target image data corresponding to all the images to be processed has been obtained, a waiting process is performed; or if the target image data corresponding to all the images to be processed has been obtained, the target request body is generated based on the target image data and the special effect associated parameters corresponding to all the first images to be processed and the third images to be processed, and a request is sent based on the target request body. Further, a request result is awaited, and when the request result is received, it is determined whether the request result is a request success. If the request result is the request success, a transition effect is rendered, and the special effect image corresponding to the first image and the third image is displayed; or if the request result is not the request success, a reason for a request failure is obtained, which may specifically include a request timeout or a return failure of the server.

According to the technical solution of this embodiment of the present disclosure, image capture is performed in response to the shooting trigger operation by using the target shooting apparatus, to obtain the first image, and the first image is displayed in the shooting interface. Further, the uploaded image is obtained as the second image in response to the uploading trigger operation, the second image is displayed in the shooting interface, and the at least one third image is determined from the second image. Still further, the target request body is generated in response to the special effect trigger operation based on all the first images to be processed and the third images to be processed, the special effect processing request is sent based on the target request body, the request result corresponding to the special effect processing request is obtained, so as to obtain the special effect image corresponding to the first image and the third image, and the special effect image is displayed. In this way, all the images to be processed and the special effect associated parameters can be sent to the server based on a single image processing request, such that the flexibility of special effect processing is improved, and the efficiency of special effect processing is improved.

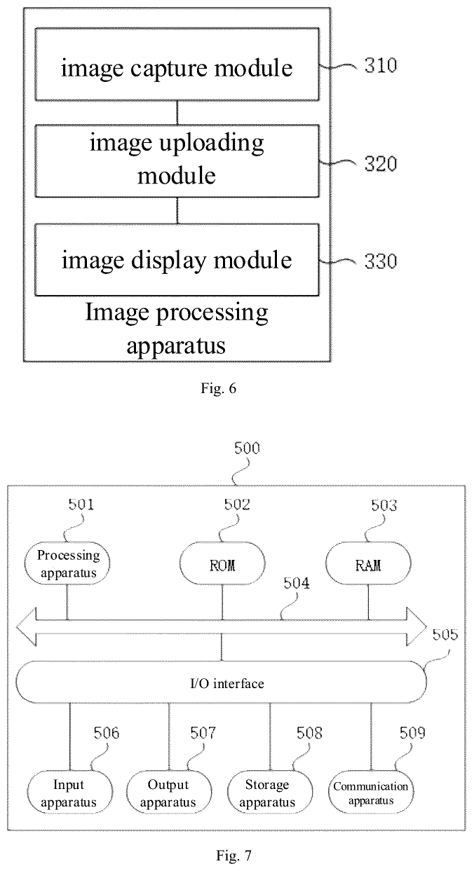

FIG. 6 is a schematic diagram of a structure of a special effect processing apparatus according to an embodiment of the present disclosure. As shown in FIG. 6, the apparatus includes an image capture module 310, an image uploading module 320, and an image display module 330.

The image capture module 310 is configured to perform, in response to a shooting trigger operation, image capture by using a target shooting apparatus, to obtain a first image, and display the first image in a shooting interface. The image uploading module 320 is configured to obtain an uploaded image as a second image in response to an uploading trigger operation, display the second image in the shooting interface, and determine at least one third image from the second image. The image display module 330 is configured to display, in response to a special effect trigger operation, a special effect image corresponding to the first image and the third image.

On the basis of the above optional technical solutions, optionally, the image uploading module 320 is specifically configured to use a selected second image as the third image in response to a selection trigger operation for at least one second image.

On the basis of the above optional technical solutions, optionally, the image display module 330 includes a request body generation submodule and an image display submodule.

The request body generation submodule is configured to generate a target request body based on all first images to be processed and third images to be processed, and send a special effect processing request based on the target request body.

The image display submodule is configured to obtain a request result corresponding to the special effect processing request, so as to obtain the special effect image corresponding to the first image and the third image, and display the special effect image.

On the basis of the above optional technical solutions, optionally, the request body generation submodule includes a parameter obtaining unit, an image processing unit, and a request body generation unit.

The parameter obtaining unit is configured to fill preset receiving slots corresponding to the first image and the third image with all the first images to be processed and the third images to be processed one by one, where the preset receiving slots include a first preset slot corresponding to the first image and a second preset slot corresponding to the third image.

The image processing unit is configured to use images filling the preset receiving slots as images to be processed, and for each of the images to be processed, obtain a special effect associated parameter corresponding to an image to be processed, and process the image to be processed based on the special effect associated parameter, to obtain target image data corresponding to the image to be processed.

The request body generation unit is configured to generate the target request body based on target image data and special effect associated parameters corresponding to all the first images to be processed and the third images to be processed.

On the basis of the above optional technical solutions, optionally, the parameter obtaining unit is specifically configured to: if two or more first images and/or third image exist and the preset receiving slots corresponding to the first image and the third image have been filled with images, fill the preset receiving slot corresponding to the first image with a subsequent first image and/or the preset receiving slot corresponding to the third image with a subsequent third image after an interval of a preset number of frames or a preset duration.

On the basis of the above optional technical solutions, optionally, the special effect associated parameter includes a request associated parameter and an effect associated parameter. The request associated parameter is a parameter associated with a generation mode of the target request body, and the effect associated parameter is a parameter associated with a display effect of the special effect image. The request associated parameter includes at least a total number of images with which the preset receiving slots are to be filled and a total number of images with which the preset receiving slots have been filled.

On the basis of the above optional technical solutions, optionally, there are a plurality of third images, and the special effect image includes a plurality of images obtained by performing special effect processing on the first image and each third images.

On the basis of the above optional technical solutions, optionally, the special effect image includes a fused image of the first image and the third image, and/or a style transferred image obtained by transferring an image style of the third image to the first image or transferring an image style of the first image to the third image.

On the basis of the above optional technical solutions, optionally, the fused image of the first image and the third image is obtained by fusing at least part of image content of the first image to the associated image region in the third image.

On the basis of the above optional technical solutions, optionally, there are a plurality of special effect images. The image display module 330 is configured to perform at least one of the following operations: playing the plurality of special effect images corresponding to the first image and the third image in a preset playback order; generating a special effect video based on the plurality of special effect images corresponding to the first image and the third image, and playing the special effect video; and splicing the plurality of special effect images corresponding to the first image and the third image in a preset splicing manner based on an original size or after scaling, so as to obtain a spliced image, and displaying the spliced image.

According to the technical solution of this embodiment of the present disclosure, image capture is performed in response to the shooting trigger operation by using the target shooting apparatus, to obtain the first image, and the first image is displayed in the shooting interface. Then, the uploaded image is obtained as the second image in response to the uploading trigger operation, the second image is displayed in the shooting interface, and the at least one third image is determined from the second image. In this way, an original image to be processed can be obtained by using a plurality of image obtaining manners, achieving an effect of customizing the original image by the user and enhancing the flexibility of the image obtaining manners. Further, the special effect image corresponding to the first image and the third image is displayed in response to the special effect trigger operation. In this way, problems of a monotonous special effect display effect of a special effect image produced based on a special effect prop and the like caused by the fact that a preset template corresponding to the special effect prop cannot be edited in the related art are solved, and an effect of customizing all images required during special effect processing is achieved. Therefore, the flexibility of the special effect processing is enhanced, a special effect display effect of the special effect image is enriched, and the user experience is improved.

The special effect processing apparatus provided in this embodiment of the present disclosure can perform the special effect processing method provided in any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the scope of protection of the embodiments of the present disclosure.

FIG. 7 is a schematic diagram of a structure of an electronic device according to an embodiment of the present disclosure. Reference is made to FIG. 7 below, which is a schematic diagram of a structure of an electronic device (such as a terminal device or a server in FIG. 7) 500 suitable for implementing embodiments of the present disclosure. The terminal device in this embodiment of the present disclosure may include, but is not limited to, mobile terminals such as a mobile phone, a notebook computer, a digital broadcast receiver, a personal digital assistant (PDA), a PAD (tablet computer), a portable multimedia player (PMP), and a vehicle-mounted terminal (such as a vehicle navigation terminal), and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device 500 may include a processing apparatus (e.g., a central processing unit or a graphics processing unit) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 7 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded from a network through the communication apparatus 509 and installed, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to an embodiment of the present disclosure and the special effect processing method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium storing a computer program thereon, where the program, when executed by a processor, causes the special effect processing method according to the above embodiments to be implemented.

It should be noted that the above computer-readable medium described in the present disclosure may be a non-transitory storage medium, a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the Hypertext Transfer Protocol (HTTP), and may be connected to digital data communication (for example, a communication network) in any form or medium. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: perform, in response to a shooting trigger operation, image capture by using a target shooting apparatus, to obtain a first image, and display the first image in a shooting interface; obtain an uploaded image as a second image in response to an uploading trigger operation, display the second image in the shooting interface, and determine at least one third image from the second image; and display, in response to a special effect trigger operation, a special effect image corresponding to the first image and the third image.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases, for example, a first obtaining unit may alternatively be described as “a unit for obtaining at least two Internet protocol addresses”.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, [Example 1] provides a special effect processing method, including:

performing, in response to a shooting trigger operation, image capture by using a target shooting apparatus, to obtain a first image, and displaying the first image in a shooting interface;
obtaining an uploaded image as a second image in response to an uploading trigger operation, displaying the second image in the shooting interface, and determining at least one third image from the second image; and
displaying, in response to a special effect trigger operation, a special effect image corresponding to the first image and the third image.

According to one or more embodiments of the present disclosure, [Example 2] provides the method of Example 1, further including:

optionally, the determining at least one third image from the second image includes: using a selected second image as the third image in response to a selection trigger operation for at least one second image.

According to one or more embodiments of the present disclosure, [Example 3] provides the method of Example 1, further including:

optionally, the displaying a special effect image corresponding to the first image and the third image includes: generating a target request body based on all first images to be processed and third images to be processed, and sending a special effect processing request based on the target request body; and obtaining a request result corresponding to the special effect processing request, so as to obtain the special effect image corresponding to the first image and the third image, and displaying the special effect image.

According to one or more embodiments of the present disclosure, [Example 4] provides the method of Example 3, further including:

optionally, the generating a target request body based on all first images to be processed and third images to be processed includes: filling preset receiving slots corresponding to the first image and the third image with all the first images to be processed and the third images to be processed one by one, where the preset receiving slots include a first preset slot corresponding to the first image and a second preset slot corresponding to the third image; using images filling the preset receiving slot as images to be processed, and for each of the images to be processed, obtaining a special effect associated parameter corresponding to an image to be processed, and processing the image to be processed based on the special effect associated parameter, to obtain target image data corresponding to the image to be processed; and generating the target request body based on target image data and special effect associated parameters corresponding to all the first images to be processed and the third images to be processed.

According to one or more embodiments of the present disclosure, [Example 5] provides the method of Example 4, further including:

optionally, the filling preset receiving slots corresponding to the first image and the third image with all the first images to be processed and the third images to be processed one by one includes: if two or more first images and/or third images exist and the preset receiving slots corresponding to the first image and the third image have been filled with images, filling the preset receiving slot corresponding to the first image with a subsequent first image and/or the preset receiving slot corresponding to the third image with a subsequent third image after an interval of a preset number of frames or a preset duration.

According to one or more embodiments of the present disclosure, [Example 6] provides the method of Example 4, further including:

optionally, the special effect associated parameter includes a request associated parameter and an effect associated parameter; the request associated parameter is a parameter associated with a generation mode of the target request body, and the effect associated parameter is a parameter associated with a display effect of the special effect image; and the request associated parameter includes at least a total number of images with which the preset receiving slots are to be filled and a total number of images with which the preset receiving slots have been filled.

According to one or more embodiments of the present disclosure, [Example 7] provides the method of Example 1, further including:

optionally, the at least one third image comprises a plurality of third images, and the special effect image includes a plurality of images obtained by respectively performing special effect processing on the first image and each of the plurality of third images.

According to one or more embodiments of the present disclosure, [Example 8] provides the method of Example 1, further including:

optionally, the special effect image includes a fused image of the first image and the third image, and/or a style transferred image obtained by transferring an image style of the third image to the first image or transferring an image style of the first image to the third image.

According to one or more embodiments of the present disclosure, [Example 9] provides the method of Example 8, further including:

optionally, the fused image of the first image and the third image is obtained by fusing at least part of image content of the first image to an associated image region in the third image.

According to one or more embodiments of the present disclosure, [Example 10] provides the method of Example 1, further including:

optionally, the special effect image corresponding to the first image and the third image comprises a plurality of special effect images, and the displaying a special effect image corresponding to the first image and the third image includes at least one of the following operations: playing the plurality of special effect images corresponding to the first image and the third image in a preset playback order; generating a special effect video based on the plurality of special effect images corresponding to the first image and the third image, and playing the special effect video; and splicing the plurality of special effect images corresponding to the first image and the third image in a preset splicing manner based on an original size or after scaling, so as to obtain a spliced image, and displaying the spliced image.

According to one or more embodiments of the present disclosure, [Example 11] provides a special effect processing apparatus, including:

an image capture module configured to perform, in response to a shooting trigger operation, image capture by using a target shooting apparatus, to obtain a first image, and display the first image in a shooting interface;
an image uploading module configured to obtain an uploaded image as a second image in response to an uploading trigger operation, display the second image in the shooting interface, and determine at least one third image from the second image; and
an image display module configured to display, in response to a special effect trigger operation, a special effect image corresponding to the first image and the third image.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A special effect processing method, comprising:
performing, in response to a shooting trigger operation, image capture by using a target shooting apparatus, to obtain a first image, and displaying the first image in a shooting interface;
obtaining an uploaded image as a second image in response to an uploading trigger operation, displaying the second image in the shooting interface, and determining at least one third image from the second image; and
displaying, in response to a special effect trigger operation, a special effect image corresponding to the first image and the third image.

2. The special effect processing method according to claim 1, wherein the determining of the at least one third image from the second image comprises:
using a selected second image as the third image in response to a selection trigger operation for at least one second image.

3. The special effect processing method according to claim 1, wherein the displaying the special effect image corresponding to the first image and the third image comprises:
generating a target request body based on all first images to be processed and third images to be processed, and sending a special effect processing request based on the target request body; and
obtaining a request result corresponding to the special effect processing request, to obtain the special effect image corresponding to the first image and the third image, and displaying the special effect image.

4. The special effect processing method according to claim 3, wherein the generating of the target request body based on all first images to be processed and the third images to be processed comprises:
filling preset receiving slots corresponding to the first image and the third image with all the first images to be processed and the third images to be processed one by one, wherein the preset receiving slots comprise a first preset slot corresponding to the first image, and a second preset slot corresponding to the third image;
using images filling the preset receiving slots as images to be processed, and for each of the images to be processed, obtaining a special effect associated parameter corresponding to an image to be processed, and processing the image to be processed based on the special effect associated parameter, to obtain target image data corresponding to the image to be processed; and
generating the target request body based on target image data and special effect associated parameters corresponding to all the first images to be processed and the third images to be processed.

5. The special effect processing method according to claim 4, wherein the filling preset receiving slots corresponding to the first image and the third image with all the first images to be processed and the third images to be processed one by one comprises:
if two or more first images and/or third images exist and the preset receiving slots corresponding to the first image and the third image have been filled with images, filling a preset receiving slot corresponding to the first image with a subsequent first image and/or a preset receiving slot corresponding to the third image with a subsequent third image after an interval of a preset number of frames or a preset duration.

6. The special effect processing method according to claim 4, wherein the special effect associated parameter comprises a request associated parameter and an effect associated parameter; the request associated parameter is a parameter associated with a generation mode of the target request body, and the effect associated parameter is a parameter associated with a display effect of the special effect image; and the request associated parameter comprises at least a total number of images with which the preset receiving slots are to be filled and a total number of images with which the preset receiving slots have been filled.

7. The special effect processing method according to claim 1, wherein the at least one third image comprises a plurality of third images, and the special effect image comprises a plurality of images obtained by respectively performing special effect processing on the first image and each of the plurality of third images.

8. The special effect processing method according to claim 1, wherein the special effect image comprises a fused image of the first image and the third image, and/or a style transferred image obtained by transferring an image style of the third image to the first image or transferring an image style of the first image to the third image.

9. The special effect processing method according to claim 8, the fused image of the first image and the third image is obtained by fusing at least part of image content of the first image to an associated image region in the third image.

10. The special effect processing method according to claim 1, wherein the special effect image corresponding to the first image and the third image comprises a plurality of special effect images, and the displaying a special effect image corresponding to the first image and the third image comprises at least one of:
playing the plurality of special effect images corresponding to the first image and the third image in a preset playback order;
generating a special effect video based on the plurality of special effect images corresponding to the first image and the third image, and playing the special effect video; and
splicing the plurality of special effect images corresponding to the first image and the third image in a preset splicing manner based on an original size or after scaling, so as to obtain a spliced image, and displaying the spliced image.

11. An electronic device, comprising:
one or more processors; and
a storage apparatus configured to store one or more programs, wherein
the one or more programs, when executed by the one or more processors, is configured for:
performing, in response to a shooting trigger operation, image capture by using a target shooting apparatus, to obtain a first image, and displaying the first image in a shooting interface;
obtaining an uploaded image as a second image in response to an uploading trigger operation, displaying the second image in the shooting interface, and determining at least one third image from the second image; and
displaying, in response to a special effect trigger operation, a special effect image corresponding to the first image and the third image.

12. The electronic device according to claim 11, wherein the determining of the at least one third image from the second image comprises:
using a selected second image as the third image in response to a selection trigger operation for at least one second image.

13. The electronic device according to claim 11, wherein the displaying of the special effect image corresponding to the first image and the third image comprises:
generating a target request body based on all first images to be processed and third images to be processed, and sending a special effect processing request based on the target request body; and
obtaining a request result corresponding to the special effect processing request, to obtain the special effect image corresponding to the first image and the third image, and displaying the special effect image.

14. The electronic device according to claim 13, wherein the generating of the target request body based on all first images to be processed and the third images to be processed comprises:
filling preset receiving slots corresponding to the first image and the third image with all the first images to be processed and the third images to be processed one by one, wherein the preset receiving slots comprise a first preset slot corresponding to the first image, and a second preset slot corresponding to the third image;
using images filling the preset receiving slots as images to be processed, and for each of the images to be processed, obtaining a special effect associated parameter corresponding to an image to be processed, and processing the image to be processed based on the special effect associated parameter, to obtain target image data corresponding to the image to be processed; and
generating the target request body based on target image data and special effect associated parameters corresponding to all the first images to be processed and the third images to be processed.

15. The electronic device according to claim 14, wherein the filling preset receiving slots corresponding to the first image and the third image with all the first images to be processed and the third images to be processed one by one comprises:
if two or more first images and/or third images exist and the preset receiving slots corresponding to the first image and the third image have been filled with images, filling a preset receiving slot corresponding to the first image with a subsequent first image and/or a preset receiving slot corresponding to the third image with a subsequent third image after an interval of a preset number of frames or a preset duration.

16. The electronic device according to claim 15, wherein the special effect associated parameter comprises a request associated parameter and an effect associated parameter; the request associated parameter is a parameter associated with a generation mode of the target request body, and the effect associated parameter is a parameter associated with a display effect of the special effect image; and the request associated parameter comprises at least a total number of images with which the preset receiving slots are to be filled and a total number of images with which the preset receiving slots have been filled.

17. A non-transitory storage medium containing computer-executable instructions, wherein the computer-executable instructions, when executed by a computer processor, are used to perform the special effect processing method according to claim 1.
